(19) United States
(12) Patent Application Publication
(10) Pub. No.: US 2024/0021349 A1
(43) Pub. Date: Jan. 18, 2024

(54) PERMANENT MAGNET AND ITS MANUFACTURING METHOD, AND DEVICE

(71) Applicant: TOKIN CORPORATION, Sendai-shi, Miyagi (JP)

(72) Inventor: Hirokazu MAKUTA, Sendai-shi, Miyagi (JP)

(21) Appl. No.: 18/256,189

(22) PCT Filed: Dec. 8, 2021
(86) PCT No.: PCT/JP2021/045177

§ 371 Date: Jun. 6, 2023

(30) Foreign Application Priority Data
Dec. 8, 2020 (JP) 2020-203239

(51) Int. Cl. H01F 1/055; C22C 38/00; C22C 38/14; C22C 38/10

(52) U.S. Cl. CPC H01F 1/0551; C22C 38/005; C22C 38/14; C22C 38/10; C22C 38/002; C22C 2202/02; B22F 3/12

(57) ABSTRACT

A permanent magnet having a high coercivity, a method for manufacturing such a permanent magnet, and a device using such a permanent magnet are provided. The permanent magnet has a composition represented by a below-shown Formula (1). Formula (1): (R1-xZrx)a(T1-yMy)bBc. In Formula (1); R is at least one element selected from rare earth elements; T is at least one element selected from a group consisting of Fe, Co and Ni; M is at least one element selected from a group consisting of Al, Si, Ti, V, Cr, Mn, Cu, Hf, Nb, Mo, Ta and W; and each of a, b and c indicates atomic %, and x and y indicate ratios of Zr and M, respectively; and they are numbers that satisfy below-shown Expressions, 5≤a≤12, b=100−(a+c), 0.1≤c≤20, 0.01≤x≤0.5, and 0.01≤y≤0.5.

### TECHNICAL FIELD

The present invention relates to a permanent magnet and its manufacturing method, and a device.

### BACKGROUND ART

There is a demand for a permanent magnet having high remanence and high heat resistance. Candidates for materials for such a magnet include SmFe₁₂-based compounds having a ThMn₁₂-type tetragonal structure having high saturation magnetization and a high Curie temperature.

For example, Patent Literature 1 discloses, as a permanent magnet which has excellent saturation magnetization and a coercivity and of which the temperature characteristic of the coercivity has been improved, a permanent magnet composed of an alloy having a hard magnetic phase having a ThMn₁₂-type tetragonal structure and a non-magnetic phase.

Further, Patent Literature 2 discloses, as a magnet material for enhancing saturation magnetization, a magnet material having a main phase composed of a ThMn₁₂-type crystalline phase and having a specific composition.

### CITATION LIST

### Patent Literature

Patent Literature 1: Japanese Unexamined Patent Application Publication No. 2001-189206
Patent Literature 2: Japanese Unexamined Patent Application Publication No. 2018-125512

### SUMMARY OF INVENTION

In the above-described permanent magnet having the ThMn₁₂-type tetragonal structure, it has been desired to further increase the coercivity thereof.

The present invention has been made to solve the above-described problem, and an object thereof is to provide a permanent magnet having a ThMn₁₂-type tetragonal structure and a high coercivity, a method for manufacturing such a permanent magnet, and a device using such a permanent magnet.

### Solution to Problem

A permanent magnet according to the present invention has a composition represented by a below-shown Formula (1),

(R₁₋ₓZrₓ)ₐ(T_{1-y}M_{y})_{b}B_{c} Formula (1):
in which, in Formula (1),
R is at least one element selected from rare earth elements,
T is at least one element selected from a group consisting of Fe, Co and Ni,
M is at least one element selected from a group consisting of Al, Si, Ti, V, Cr, Mn, Cu, Hf, Nb, Mo, Ta and W,
each of a, b and c indicates atomic %, and x and y indicate ratios of Zr and M, respectively; and they are numbers that satisfy below-shown Expressions,
5≤a≤12,
b=100−(a+c),
0.1≤c≤20,
0.01≤x≤0.5, and
0.01≤y≤0.5.

An embodiment of the above-described permanent magnet contains a grain composed of a main phase having a ThMn₁₂-type crystal structure, and a grain boundary; and the grain boundary contains an amorphous phase.

In an embodiment of the above-described permanent magnet, 50 atomic % or more of the R is Sm.

In an embodiment of the above-described permanent magnet, 50 atomic % or more of the T is Fe.

In an embodiment of the above-described permanent magnet, the a is a number that satisfies 5≤a≤8.

In an embodiment of the above-described permanent magnet, a coercivity (Hcj) is 1.8 kOe or larger.

In an embodiment of the above-described permanent magnet, a Curie temperature exceeds 400° C.

In an embodiment of the above-described permanent magnet, a ratio (atomic %) of the element B in the grain boundary is 10 times or higher than the ratio of the element B in the grain.

In an embodiment of the above-described permanent magnet, an intensity ratio (I_{α-Fe}/I_{ThMn12}) of a peak intensity (I_{α-Fe}) of a peak corresponding to a 110-surface of α-iron to a peak intensity (I_{ThMn12}) of a peak corresponding to a 321-surface of the ThMn₁₂-type crystal structure in an X-ray diffraction spectrum is 1.0 or lower.

A method for manufacturing a permanent magnet according to the present invention includes:
a step (I) of preparing a molten metal having a composition represented by the above-shown Formula (1);
a step (II) of quenching the molten metal at a rate of 10² to 10⁷ K/sec and thereby forming an alloy thereof;
a step (III) of pulverizing the alloy and thereby forming a powder thereof;
a step (IV) of molding the powder into a molded body;
a step (V) of sintering the molded body into a sintered body; and
a step (VI) of heat-treating the sintered body and then quenching the sintered body.

Further, a device according to the present invention is characterized in that the device includes the above-described permanent magnet.

### Advantageous Effects of Invention

According to the present invention, a permanent magnet having a ThMn₁₂-type tetragonal structure and a high coercivity, a method for manufacturing such a permanent magnet, and a device using such a permanent magnet are provided.

### BRIEF DESCRIPTION OF DRAWINGS

FIG. 1 shows X-ray diffraction spectra of permanent magnets according to examples and those according to comparative examples.

### DESCRIPTION OF EMBODIMENTS

A permanent magnet, a manufacturing method, and a device according to an embodiment will be described. Note that a numerical range such as “n-m” or “n to m” (i.e., “from n to m”) includes the lower and upper limit values, unless otherwise specified.

### [Permanent Magnet]

A permanent magnet according to this embodiment (hereinafter also referred to as the permanent magnet) is characterized in that the permanent magnet has a composition represented by the below-shown Formula (1).

(R₁₋ₓZrₓ)ₐ(T_{1-y}M_{y})_{b}B_{c} Formula (1):
in which, in Formula (1),
R is at least one element selected from rare earth elements,
T is at least one element selected from a group consisting of Fe, Co and Ni,
M is at least one element selected from a group consisting of Al, Si, Ti, V, Cr, Mn, Cu, Hf, Nb, Mo, Ta and W,
each of a, b and c indicates atomic %, and x and y indicate ratios of Zr and M, respectively; and they are numbers that satisfy below-shown Expressions,
5≤a≤12,
b=100−(a+c),
0.1≤c≤20,
0.01≤x≤0.5, and
0.01≤y≤0.5.

R in the Formula (1) represents a rare earth element. In this embodiment, the rare earth element is a general term for elements including lanthanoids from La (lanthanum) to Lu (lutetium), and Sc (scandium) and Y (yttrium). R contains one or more elements selected from the aforementioned rare earth elements. By containing R in a range that satisfies the above-shown Formula (1), a permanent magnet having high magnetic anisotropy and a high coercivity can be obtained. In view of the magnetic anisotropy and the coercivity, R preferably contains at least one element selected from Sm, Pr, Nd, Ce and La, and more preferably contains Sm. Further, in view of the magnetic anisotropy and the coercivity, 50 atomic % or more of R is preferably Sm. Preferably, 80 atomic % or more of R is Sm, and more preferably, R is substantially Sm.

The permanent magnet contains Zr in a range in which a ratio (atomic %) of R to Zr is (1−x):x. By containing Zr in the aforementioned range, it is possible to stabilize the ThMn₁₂-type crystal structure while reducing the content of an M element described later, and as a result, the saturation magnetization is improved. In order to stabilize the ThMn₁₂-type crystal structure, x should be 0.01 to 0.5. Further, in view of the magnetic anisotropy and the coercivity, x is preferably 0.2 or less.

To make the ThMn₁₂-type crystal structure the main phase, the ratio (a) the total content of R and Zr to the whole permanent magnet is 5 to 12. In order to increase the magnetization, a is preferably 10 or lower, and more preferably 8 or lower.

T in the Formula (1) represents at least one element selected from a group consisting of Fe, Co and Ni. Each element of T contributes to the magnetization of the permanent magnet. In order to increase the magnetization, T preferably includes Fe. Further, in order to increase the Curie temperature and improve the heat resistance, T preferably includes Co. In order to increase the magnetization, 50 atomic % or more of T is preferably Fe, and 60 atomic % or more of T is preferably Fe. Further, for example, when a combination of Fe and Co is used, the ratio (atomic %) of Fe to Co is preferably 60:40 to 95:5, and more preferably 70:30 to 80:20.

M in the Formula (1) represents at least one element selected from a group consisting of Al, Si, Ti, V, Cr, Mn, Cu, Hf, Nb, Mo, Ta and W. The permanent magnet contains M in a range in which a ratio (atomic %) of T to M is (1−y):y. Each element of M contributes to the stability of the ThMn₁₂-type crystal structure. By containing M in the aforementioned range, the stability of the ThMn₁₂-type crystal structure is improved while suppressing the decrease in the saturation magnetization. In view of the stability of the crystal structure, y should be 0.01 or higher, and is preferably 0.02 or higher. On the other hand, in order to suppress the decrease in the saturation magnetization, y should be 0.5 or less, and is preferably 0.1 or less.

The ratio (b) of the total content of T and M to the whole permanent magnet can be expressed as 100−(a+c), and to make the ThMn₁₂-type crystal structure the main phase, the ratio (b) of the total content is 70 to 94. In order to increase the magnetization, b is preferably 75 or higher, and more preferably 77 or higher.

Further, the permanent magnet contains 0.1 to 20 atomic % of B (boron). By containing 0.1 atomic % or more of B (0.1≤c), the precipitation of α-iron (ferrite phase) is suppressed during the cooling of the permanent magnet in the manufacturing thereof, so that the coercivity (Hcj) thereof is improved. In order to suppress the precipitation of α-iron, the content ratio (c) of B is preferably 0.5 or higher.

Further, it is presumed that amorphous phases are formed at grain boundaries by adjusting the content ratio (c) of B to 1 or higher and preferably using a manufacturing method described later. The amorphous phases serve as domain wall pinning sites and thereby increase the coercivity of the permanent magnet. In order to further increase the coercivity by forming amorphous phases, the content ratio (c) of B is preferably 1.2 or higher, and more preferably 1.5 or higher. On the other hand, in order to suppress the decrease in the saturation magnetization, the content ratio (c) of B is preferably 15 or lower, and more preferably 10 or lower.

The permanent magnet may contain unavoidable impurities in a range in which effects of the present invention are obtained. The unavoidable impurities are elements that are unavoidably mixed from the raw materials or during the manufacturing process, and are elements that are not included in the Formula (1) (elements other than R, T, M, Zr and B). Specifically, they include, but are not limited to, O, C, N, P, S and Sn. The ratio of unavoidable impurities in the permanent magnet is, based on the total amount of the permanent magnet, preferably 5 atomic % or lower, more preferably 1 atomic % or lower, and further preferably 0.1 atomic % or lower.

The content ratio of each element contained in the permanent magnet can be measured, for example, by using energy dispersive X-ray spectroscopy (EDX: Energy dispersive X-ray spectrometry).

By making the composition of the permanent magnet satisfy the above-shown Formula (1), the permanent magnet contains grains composed of main phases having ThMn₁₂-type crystal structures, and grain boundaries that serve as boundaries between the grains. The permanent magnet is excellent in the stability of the ThMn₁₂-type crystal structure, the saturation magnetization, the coercivity, and the heat resistance.

In particular, in the permanent magnet, B (boron) is preferably concentrated on the grain boundary side by a manufacturing method described later. For example, in the permanent magnet, the ratio (atomic %) of the element B at the grain boundaries can be adjusted to 10 times or higher than the ratio of the element B in the grains. As a result, the coercivity is further improved.

As an example, the permanent magnet has a coercivity (Hcj) of 1.8 kOe or larger, and preferably 2.0 or higher. Further, it is possible to obtain, as an example, a permanent magnet having a Curie temperature exceeding 400° C.

Note that the structures of grain boundaries can be observed by using a scanning transmission electron microscope (STEM). The Curie temperature can be measured by using a vibrating sample magnetometer (VSM). Further, the coercivity can be determined from a J-H curve that is obtained by using a DC (Direct-Current) magnetization characteristic analyzer.

### [Method for Manufacturing Rare Earth Cobalt Permanent Magnet]

A method for manufacturing a permanent magnet according to the embodiment (hereinafter also referred to as the manufacturing method) includes:
a step (I) of preparing a molten metal having a composition represented by the above-shown Formula (1);
a step (II) of quenching the molten metal at a rate of 10² to 10⁷ K/sec and thereby forming an alloy thereof;
a step (III) of pulverizing the alloy and thereby forming a powder thereof;
a step (IV) of molding the powder into a molded body;
a step (V) of sintering the molded body into a sintered body; and
a step (VI) of heat-treating the sintered body and then quenching the sintered body.

By the manufacturing method, it is possible to suitably manufacture a permanent magnet containing grains composed of main phases having ThMn₁₂-type crystal structures, and grain boundaries that serve as boundaries between the grains, in which the grain boundaries have amorphous phases.

Firstly, a molten metal having a composition represented by the above-shown Formula (1) is prepared (Step (I)). Regarding the method for preparing the molten metal, the molten metal may be prepared by obtaining a commercially-available product of an alloy having a desired composition, or an alloy may be prepared by blending elements so that a desired composition is obtained. Note that when there is a possibility that some element(s) may evaporate in a later step, the amounts of the elements are adjusted so that the composition of the manufactured permanent magnet satisfies the above-shown Formula (1). The prepared alloy is melted into a molten metal. The melting method can be selected as appropriate from known melting methods such as arc melting and high-frequency melting.

Next, the molten metal is quenched at a rate of 10² to 10⁷ K/sec (Step (II)). By quenching the molten metal at a cooling rate of 10² K/sec or higher, an alloy of which the precipitation of α-Fe (α-iron) is suppressed can be obtained. By suppressing the precipitation of α-Fe, amorphous phases can be suitably formed at grain boundaries, so that a permanent magnet having a high coercivity can be obtained. The quenched alloy may be further heat-treated in order to make the structures uniform. The quenching rate is preferably 10′ to 106 K/sec. Further, the alloy is preferably made into thin flakes in order to suppress the precipitation of α-iron which would otherwise be caused by the quenching. To make the quenching easier, the thickness of the thin flakes is preferably 1 to 100 μm and more preferably 20 to 90 μm. Note that as the above-described alloy contains boron, its viscosity decreases. Therefore, thin flakes having the aforementioned thickness are easily obtained when the molten metal is quenched by a melt-spun method or the like.

The amount of α-iron can be evaluated, for example, by an X-ray diffraction spectrum. Specifically, it is possible to measure an X-ray diffraction spectrum of the permanent magnet by using Kα-characteristic X-rays of Cu, and thereby to estimate the degree of the precipitation of α-iron from an intensity ratio (I_{α-Fe}/I_{ThMn12}) of a peak intensity (I_{α-Fe}) of a peak corresponding to a 110-surface of α-iron to a peak intensity (I_{ThMn12}) of a peak corresponding to a 321-surface of the ThMn₁₂-type crystal structure, which is the main phase.

Note that as the peak intensity, a value obtained by subtracting background from a peak height is used, and the intensity ratio is preferably 1.0 or lower and more preferably 0.8 or lower. Note that the lower the intensity ratio is, the more desirable it is. Further, the lower limit is not particularly limited, but is usually 0.001 or higher.

Next, the alloy is pulverized (Step (III)). The method for pulverizing the alloy may be selected as appropriate from known methods. As an example, firstly, the alloy is coarsely pulverized by a known pulverizer such as a disc mill in an inert atmosphere. If the alloy is not satisfactorily pulverized, the alloy may be subjected to a hydrogen storing process in advance. The alloy is made brittles by the hydrogen storing process, so that the alloy can be easily coarsely pulverized.

Next, the coarsely pulverized alloy is further finely pulverized. The fine pulverization may be dry pulverization or wet pulverization. Examples of dry pulverization include jet milling. Further, examples of wet pulverization include wet ball milling. A lubricant may be added to the powder during the pulverization in order to give lubricity to the powder. Further, the mixture of an organic solvent and the fine powder after the pulverization is dried in an inert gas. To make it possible to shorten the sintering time of a sintering process described later, and to manufacture a uniform permanent magnet, the average particle diameter of the powder after the pulverization is preferably 1 to 10 μm.

Next, the obtained powder is pressure-molded into a molded body having a desired shape (Step (IV)). In the present invention, in order to align the orientations of crystals of the powder and thereby improve the magnetic characteristics thereof, the obtained powder is preferably pressure-molded in a constant magnetic field. The relationship between the direction of the magnetic field and the pressing direction is not particularly limited, and may be selected as appropriate according to the shape or the like of the product. For example, when a ring magnet or a thin-plate-shaped magnet is manufactured, parallel magnetic-field pressing in which the magnetic field is applied parallel to the pressing direction can be adopted. On the other hand, to obtain excellent magnetic characteristics, right-angle magnetic-field pressing in which the magnetic field is applied at a right angle with respect to the pressing direction can be adopted.

The magnitude of the magnetic field is not particularly limited, and the magnetic field may be, for example, 15 kOe or smaller, or may be 15 kOe or larger depending on the use or the like of the product. In particular, to obtain excellent magnetic characteristics, the powder is preferably pressure-molded in a magnetic field of 15 kOe or larger. Further, the pressure during the pressure molding can be adjusted as appropriate according to the size, shape, or the like of the product. As an example, the pressure can be 0.5 to 2.0 ton/cm². That is, in the method for manufacturing the permanent magnet, in view of the magnetic characteristics, the powder is preferably pressure-molded in a magnetic field of 15 kOe or larger with a pressure of 0.5 to 2.0 ton/cm² or lower that is applied perpendicular to the magnetic field.

Next, the molded body is sintered into a sintered body (Step (V)). The sintering temperature is preferably 950 to 1,250° C. and more preferably 950 to 1,220° C. Further, the sintering time is preferably 20 to 240 minutes and more preferably 60 to 120 minutes. By performing the sintering at 950° C. or higher for 20 minutes or longer, the sintered body is sufficiently densified. Further, by heating the molded body at 1,250° C. or lower for 240 minutes or shorter, the evaporation of the rare earth elements, especially Sm, is suppressed. Further, in order to suppress the oxidation, the above-described sintering step is preferably carried out in a vacuum of 1,000 Pa or lower or in an inert gas atmosphere. Further, in order to increase the density of the sintered body, the sintering is preferably carried out in a vacuum of 1,000 Pa or lower, and preferably 100 Pa or lower.

After the above-described step (V), the obtained sintered body is preferably heat-treated in a continuous manner. Through the heat-treatment, ThMn₁₂-type crystal structures are formed and Fe—B liquid phase components are generated at the grain boundaries. The heat-treatment temperature is preferably 500 to 1,180° C. and more preferably 500 to 900° C. By heat-treating the sintered body at 500° C. or higher, the structures are made uniform and the formation of ThMn₁₂ type structures is expedited. Further, the above-described liquid phase components are easily obtained. On the other hand, by heat-treating the sintered body at 1,180° C. or lower, the liquid phase components are prevented from excessively increasing and the deterioration of the magnetic characteristics is suppressed. The heat-treatment time can be, for example, 1 to 100 hours and preferably 5 to 50 hours.

Next, the heat-treated sintered body is quenched (Step (VI)). By the quenching, amorphous phases are formed at the grain boundaries. The quenching rate in the step (VI) should be 60 to 250° C./min, and is preferably 100 to 250° C./min.

The obtained sintered body may be further aged as required. Through the above-described processes, it is possible to manufacture a permanent magnet containing grains composed of main phases having ThMn₁₂-type crystal structures, and grain boundaries that serve as boundaries between the grains, in which the grain boundaries have amorphous phases.

### [Device]

The present invention can further provide a device including the above-described permanent magnet. Specific examples of such a device include a clock (a watch), an electric motor, various instruments (meters), a communication apparatus, a computer terminal, a speaker, a video disk, and a sensor. Further, since the magnetic force of the permanent magnet according to the present invention is less likely to deteriorate even at a high environmental temperature, it can be suitably used for an angle sensor and an ignition coil used in an engine room of an automobile, and a driving motor of an HEV (Hybrid Electric Vehicle) or the like.

### EXAMPLES

The present invention will be described hereinafter in a concrete manner by using examples and comparative examples. Note that their descriptions do not limit the present invention.

### Example 1

Each metal was weighed to have a predetermined amount so that a composition shown in Table 1 was obtained, and a base alloy was obtained by high-frequency melting. This base alloy was melted again by high-frequency melting and quenched at a rate of 10² to 10⁷ K/sec by a melt-span method. As a result, alloy flakes having a thickness shown in Table 1 were obtained. Next, the alloy flakes were coarsely pulverized by a vibration mill and finely pulverized by a wet ball mill. As a result, a raw-material powder was obtained. This raw-material powder was molded into a compact by pressing in a magnetic field. The compact was sintered, and was heat-treated in a continuous manner. The sintering temperature was 1,000° C. and the heat-treatment temperature was 900° C. After the heat treatment, a permanent magnet according to Example 1 was obtained by quenching the compact.

### Examples 2 and 3

Permanent magnets according to Examples 2 and 3 were obtained in a manner similar to that in Example 1 except that the compositions and the heat-treatment temperatures were changed as shown in Table 1.

### Comparative Examples 1 to 3

Permanent magnets according to Comparative Examples 1 to 3 were obtained in a manner similar to that in Example 1 except that the compositions, the thicknesses of the thin flakes, and the heat-treatment temperatures were changed as shown in Table 1.

### [Evaluation]

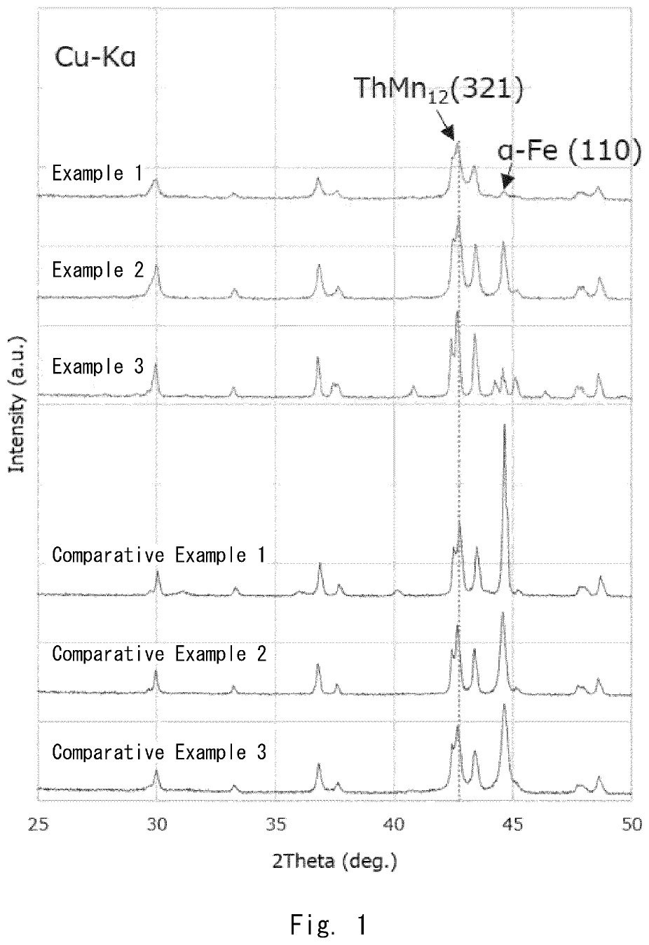

X-ray diffraction spectra of the permanent magnets according to the above-described examples and the comparative examples were measured. FIG. 1 shows the results. Further, from the X-ray diffraction spectra shown in FIG. 1, peak intensities (I_{ThMn12}) of peaks corresponding to 321-surfaces of ThMn₁₂-type crystal structures and peak intensities (I_{α-Fe}) of peaks corresponding to 110-surfaces of α-iron were determined, and ratios therebetween were calculated. Table 1 shows the results.

Further, a J-H curve of each permanent magnet was measured by using a DC magnetization characteristic analyzer, and a coercivity Hcj thereof was obtained. Table 1 shows the results.

TABLE 1

| | | | Heat- | | |
|---|---|---|---|---|---|
| | | Thin-flake | treatment | | |
| | | thickness | temperature | | Hcj |
| | Composition Formula | (μm) | (° C.) | I_{α-Fe}/I_{TbMn12} | (kOc) |
| Example 1 | (Sm_{0.8}Zr_{0.2})_{8.6}(Fe_{0.69}Co_{0.23}Ti_{0.08})_{90.6}B_{0.8} | 60-80 | 900 | 0.13 | 4.2 |
| Example 2 | (Sm_{0.8}Zr_{0.2})_{7.7}(Fe_{0.69}Co_{0.23}Ti_{0.08})_{91.5}B_{0.8} | 60-80 | 800 | 0.71 | 2.5 |
| Example 3 | (Sm_{0.8}Zr_{0.2})_{8.1}(Fe_{0.69}Co_{0.23}Ti_{0.08})_{91.2}B_{0.7} | 60-80 | 1000 | 0.34 | 2.0 |
| Comparative | (Sm_{0.8}Zr_{0.2})_{7.7}(Fe_{0.72}Co_{0.24}Ti_{0.04})_{92.3} | 100-200 | 800 | 2.34 | 0.6 |
| Example 1 | | | | | |
| Comparative | (Sm_{0.8}Zr_{0.2})_{7.7}(Fe_{0.72}Co_{0.24}Ti_{0.04})_{92.3} | 100-200 | 700 | 1.20 | 0.7 |
| Example 2 | | | | | |
| Comparative | (Sm_{0.8}Zr_{0.2})_{7.7}(Fe_{0.69}Co_{0.23}Ti_{0.08})_{92.3} | 100-200 | 700 | 1.35 | 1.6 |
| Example 3 | | | | | |

As shown in Table 1, it was shown that in each of the permanent magnets according to Examples 1 to 3, each of which contained 0.1 atomic % or more of boron, the precipitation of α-iron was suppressed and the coercivity was excellent.

### Examples 4 and 5

Raw material base alloys were manufactured by weighing each metal so as to have a predetermined amount so that compositions shown in Table 2 were obtained, high-frequency-melting the metals, and quenching them at a rate of 10² to 10⁷ K/sec by using a quenching thin-strip manufacturing apparatus. The alloys were heat-treated at 800 to 1,180° C., so that the compositions were homogenized. After that, the alloys were heated at a temperature of 200 to 600° C. in a hydrogen stream, so that hydrogen was stored therein. The alloys were coarsely pulverized by a disc mill, and were finely pulverized in a 2-propanol solvent by a ball mill. During the fine pulverization, a lubricant was added. As a result, lubricity was given to the powder, thus making magnetic alignment in a molding process performed later easier. Slurry composed of the solvent, the lubricant, and the fine powder was pressure-dried by a nitrogen gas, and the obtained raw-material powder was molded in a magnetic field. The molded body was heated in a hydrogen stream and subjected to a decarbonization heat treatment. After that, the atmosphere was switched to a vacuum and the temperature was raised. Then, the molded body was sintered at 1,200° C. in an Ar atmosphere of 30 kPa, further heat treated at 800 to 1,180° C. in a continuous manner, and lastly quenched. As a result, permanent magnets according to Examples 4 and 5 were obtained.

### Comparative Example 4

A permanent magnet according to Comparative Example 1 was obtained in a manner similar to those in Examples 4 and 5 except that the composition was changed as shown in Table 2.

### [Evaluation]

J-H curves of the permanent magnets were measured by using a DC magnetization characteristic analyzer, and saturation magnetization (4πIs) and coercivities Hcj thereof were obtained.

Table 2 shows the results.

TABLE 2

| | Composition Formula | 4πIs (kG) | Hcj (kOe) |
|---|---|---|---|
| Example 4 | (Sm_{0.8}Zr_{0.2})_{7.5}(Fe_{0.72}Co_{0.24}Ti_{0.04})_{90.3}B_{1.6} | 15.3 | 4 |
| Example 5 | (Sm_{0.8}Zr_{0.2})_{7.4}(Fe_{0.72}Co_{0.24}Ti_{0.04})_{88.9}B_{3.7} | 15 | 10 |
| Comparative Example 4 | (Sm_{0.8}Zr_{0.2})_{7.7}(Fe_{0.72}Co_{0.24}Ti_{0.04})_{92.3} | 16 | 1 |

As shown in Table 2, it was shown that each of the permanent magnets according to Examples 4 and 5, of which the composition satisfies the above-shown Formula (1), has an excellent coercivity while maintaining high saturation magnetization. The structure of each of the permanent magnets according to Examples 4 and 5 was observed by using a scanning transmission electron microscope (STEM), and grains having ThMn₁₂-type crystal structures and grain boundaries containing amorphous phases were confirmed (i.e., observed). Further, it was confirmed that in each of the permanent magnets according to Examples 4 and 5, the element B was concentrated into amorphous phases (grain boundaries), and the atomic % concentration the element B in the amorphous phases was 10 times or higher that of the element B in the grains. In contrast, the permanent magnet according to Comparative Example 4, which did not contain B, had no amorphous phase at the grain boundaries.

This application is based upon and claims the benefit of priority from Japanese patent application No. 2020-203239, filed on Dec. 8, 2020, the disclosure of which is incorporated herein in its entirety by reference.

1. A permanent magnet having a composition represented by a below-shown Formula (1),
(R₁₋ₓZrₓ)ₐ(T_{1-y}M_{y})_{b}B_{c} Formula (1):
in which, in Formula (1),
R is at least one element selected from rare earth elements,
T is at least one element selected from a group consisting of Fe, Co and Ni,
M is at least one element selected from a group consisting of Al, Si, Ti, V, Cr, Mn, Cu, Hf, Nb, Mo, Ta and W,
each of a, b and c indicates atomic %, and x and y indicate ratios of Zr and M, respectively; and they are numbers that satisfy below-shown Expressions,
5≤a≤12,
b=100−(a+c),
0.1≤c≤20,
0.01≤x≤0.5, and
0.01≤y≤0.5.

2. The permanent magnet according to claim 1, containing a grain composed of a main phase having a ThMn₁₂-type crystal structure, and a grain boundary, wherein the grain boundary contains an amorphous phase.

3. The permanent magnet according to claim 1, wherein 50 atomic % or more of the R is Sm.

4. The permanent magnet according to claim 1, wherein 50 atomic % or more of the T is Fe.

5. The permanent magnet according to claim 1, wherein the a is a number that satisfies 5≤a≤8.

6. The permanent magnet according to claim 1, wherein a coercivity (Hcj) is 1.8 kOe or larger.

7. The permanent magnet according to claim 1, wherein a Curie temperature exceeds 400° C.

8. The permanent magnet according to claim 2, wherein a ratio (atomic %) of the element B in the grain boundary is 10 times or higher than the ratio of the element B in the grain.

9. The permanent magnet according to claim 1, wherein an intensity ratio (I_{α-Fe}/I_{ThMn12}) of a peak intensity (I_{α-Fe}) of a peak corresponding to a 110-surface of α-iron to a peak intensity (I_{ThMn12}) of a peak corresponding to a 321-surface of the ThMn₁₂-type crystal structure in an X-ray diffraction spectrum is 1.0 or lower.

10. A method for manufacturing a permanent magnet comprising:
a step (I) of preparing a molten metal having a composition represented by a below-shown Formula (1);
a step (II) of quenching the molten metal at a rate of 10² to 10⁷ K/sec and thereby forming an alloy thereof;
a step (III) of pulverizing the alloy and thereby forming a powder thereof;
a step (IV) of molding the powder into a molded body;
a step (V) of sintering the molded body into a sintered body; and
a step (VI) of heat-treating the sintered body and then quenching the sintered body,
(R₁₋ₓZrₓ)ₐ(T_{1-y}M_{y})_{b}B_{c} Formula (1):
in which, in Formula (1),
R is at least one element selected from rare earth elements,
T is at least one element selected from a group consisting of Fe, Co and Ni,
M is at least one element selected from a group consisting of Al, Si, Ti, V, Cr, Mn, Cu, Hf, Nb, Mo, Ta and W,
each of a, b and c indicates atomic %, and x and y indicate ratios of Zr and M, respectively; and they are numbers that satisfy below-shown Expressions,
5≤a≤12,
b=100−(a+c),
0.1≤c≤20,
0.01≤x≤0.5, and
0.01≤y≤0.5.

11. A device including a permanent magnet according to claim 1.
